(19) United States
(12) Patent Application Publication
(10) Pub. No.: US 2024/0411101 A1
(43) Pub. Date: Dec. 12, 2024

(54) IMAGE CAPTURE AND LIGHT PROJECTION USING AT LEAST ONE LENS UNIT HAVING A TELECENTRIC IMAGE PLANE OR A TELECENTRIC OBJECT PLANE

(71) Applicant: NIL Technology ApS, Kongens Lyngby (DK)

(72) Inventors: Fredrik Mattinson, Täby (SE); James Eilertsen, Skodsborg (DK); Olivier Francois, Kongens Lyngby (DK)

(21) Appl. No.: 18/698,919

(22) PCT Filed: Oct. 4, 2022
(86) PCT No.: PCT/EP2022/077599

§ 371 Date: Apr. 5, 2024

Related U.S. Application Data
(60) Provisional application No. 63/252,704, filed on Oct. 6, 2021.

(51) Int. Cl. G02B 7/02; G02B 1/00; G02B 13/22; G03B 15/03; G03B 30/00; H04M 1/02; H04N 23/50; H04N 23/56

(52) U.S. Cl. CPC G02B 7/021; G02B 13/22; G03B 15/03; G03B 30/00; H04M 1/0216; H04M 1/0264; H04N 23/50; H04N 23/56; G02B 1/002; H04M 2250/52

(57) ABSTRACT

The disclosure describes, among other things, an image capture apparatus that includes a first lens unit, a second lens unit operable to be placed into optical alignment with the first lens unit, and an image sensor operable to acquire an image based on light signals passing through the first and second lens units when the first and second lens units are optically aligned with one another. At least one of the first or second lens units has a telecentric image plane or a telecentric object plane. Optical illumination devices such as light projectors that include at least one lens unit having a telecentric image plane or a telecentric object plane also are disclosed.

### FIELD OF THE DISCLOSURE

The present disclosure relates to image capture and light projection.

### BACKGROUND

Some electronic devices include multiple parts that are coupled together physically and can be positioned to overlap each other to provide image capture operations (e.g., for a camera). As an example, the overlap mode may provide for additional focusing options by using optical elements in a second part of the device with a main camera part in a first part of the device. However, in practice, it sometimes is difficult to achieve suitable alignment between multiple camera parts of a multi-part electronic device that can be moved relative to each other.

### SUMMARY

The present disclosure describes image capture and light projection using at least one lens unit having a telecentric image plane or a telecentric object plane.

In one aspect, the present disclosure describes an apparatus that includes a first lens unit, a second lens unit and an image sensor. The second lens unit is operable to be placed into optical alignment with the first lens unit. At least one of the first or second lens units has a telecentric image plane or a telecentric object plane. The image sensor is operable to acquire an image based on light signals passing through the first and second lens units when the first and second lens units are optically aligned with one another.

In some implementations, the apparatus includes an electronic device having first and second parts that are coupled together. The first and second parts are separated from one another by a space when the first and second lens units are optically aligned with one another. The first lens unit and the image sensor are disposed within the first part, and the second lens unit is disposed within the second part. When the first and second lens units are optically aligned with one another, the second lens unit has a telecentric image plane such that light rays passing through the second lens unit are focused on an intermediate image plane located in the space, and the first lens unit has a telecentric object plane that coincides with intermediate image plane.

In some implementations, by configuring the second lens unit to have a telecentric image plane focused in the space between the two lens units and by configuring the first lens unit to have a telecentric object plane focused in the space between the two lens units, the chief rays remain substantially parallel to the optical axis. Thus, the size of an image on the image sensor will not vary significantly even if the distance between the two lens units varies somewhat.

Some implementations include one or more of the following features. For example, in some instances, at least one of the first or second lens units includes a stack of lenses. In some cases, at least one of the first or second lens units includes a refractive lens. Further, in some cases, at least one of the first or second lens units includes a metalens.

In some implementations, the first and second parts are operable to be moved relative to one another and to be placed in an overlapping position such that the first and second lens units are optically aligned with one another. The first and second parts can be coupled to one another, for example, by a hinge about which at least one of the first or second parts can rotate.

In some instances, the second lens unit is disposed between first and second coverglasses, and the first lens unit is disposed between a third coverglass and the image sensor.

The present disclosure also describes an electronic device that includes first and second parts that are coupled together. The first part houses a first lens unit and an image sensor, and the second part houses a second lens unit. The first and second parts are operable to be moved relative to one another and to be placed in an overlapping position such that the first and second lens units are optically aligned with one another. When the first and second lens units are optically aligned with one another: the first and second parts are separated from one another by a space, the second lens unit has a telecentric image plane such that light rays passing through the second lens unit are focused on an intermediate image plane located in the space, and the first lens unit has a telecentric object plane that coincides with the intermediate image plane. The image sensor is operable to acquire an image based on light signals passing through the first and second lens units when the first and second lens units are optically aligned with one another.

In some implementations, the electronic device further includes an interactive display screen on at least one of the first or second parts.

In some cases, the electronic device is a smartphone or other handheld computing device.

The present disclosure further describes a method that includes moving first and second parts of an electronic device relative to one another. The first and second parts are coupled together. The first part houses a first lens unit and an image sensor, and the second part houses a second lens unit. Moving the first and second parts relative to one another includes placing the first and second parts in an overlapping position such that: the first and second lens units are optically aligned with one another, the first and second parts are separated from one another by a space, the second lens unit has a telecentric image plane such that light rays passing through the second lens unit are focused on an intermediate image plane located in the space, and the first lens unit has a telecentric object plane that coincides with the intermediate image plane. The method further includes causing the image sensor to acquire an image based on light signals passing through the first and second lens units while the first and second parts are in the overlapping position.

In some implementations, the method includes rotating at least one of the first and second parts about a hinge that couples the first and second parts together.

The present disclosure also describes optical illumination devices such as light projectors that include at least one lens unit having a telecentric image plane or a telecentric object plane also are disclosed.

For example, in some implementations, an apparatus includes a first lens unit, a second lens unit operable to be placed into optical alignment with the first lens unit, and a light emitter operable to produce light rays that pass through the first and second lens units when the first and second lens units are optically aligned with one another. At least one of the first or second lens units has a telecentric image plane or a telecentric object plane.

In some implementations, the apparatus includes an electronic device having first and second parts that are coupled together, wherein the first and second parts are separated from one another by a space when the first and second lens units are optically aligned with one another. The first lens unit and the light emitter are disposed within the first part, and the second lens unit is disposed within the second part. When the first and second lens units are optically aligned with one another: the first lens unit has a telecentric image plane such that light rays produced by the light emitter and passing through the first lens unit are focused on an intermediate image plane located in the space, and the second lens unit has a telecentric object plane that coincides with the intermediate image plane.

In some implementations, at least one of the first or second lens units includes a metalens. In some implementations, the light emitter includes addressable VCSELs.

The disclosure also describes an electronic device including first and second parts that are coupled together. The first part houses a first lens unit and a light emitter operable to produce light rays, and the second part houses a second lens unit. The first and second parts are operable to be moved relative to one another and to be placed in an overlapping position such that the first and second lens units are optically aligned with one another. When the first and second lens units are optically aligned with one another: the first and second parts are separated from one another by a space, the first lens unit has a telecentric image plane such that the light rays produced by the light emitter and pass through the first lens unit are focused on an intermediate image plane located in the space, and the second lens unit has a telecentric object plane that coincides with the intermediate image plane.

The disclosure further describes a method including moving first and second parts of an electronic device relative to one another, wherein the first and second parts are coupled together. The first part houses a first lens unit and a light emitter, and the second part houses a second lens unit. Moving the first and second parts relative to one another includes placing the first and second parts in an overlapping position such that: the first and second lens units are optically aligned with one another, the first and second parts are separated from one another by a space, the first lens unit has a telecentric image plane such that light rays produced by the light emitter and passing through the first lens unit are focused on an intermediate image plane located in the space, and the second lens unit has a telecentric object plane that coincides with the intermediate image plane. The method further includes causing the light emitter to produce light rays while the first and second lens units are optically aligned with one another. In some implementations, the light rays pass through the first and second lens units and form a pattern on one or more objects.

In some implementations, the techniques described here can give optical designers more freedom when designing the optics for image capture or light projection.

Other aspects, features and advantages will be readily apparent from the following detailed description, the accompany drawings and the claims.

### BRIEF DESCRIPTION OF THE DRAWINGS

FIG. 1 illustrates an example of an electronic device that includes a camera unit.

FIG. 2A shows an example of a foldable electronic device in an open position.

FIG. 2B shows the foldable electronic device of FIG. 2A in a closed position.

FIG. 2C shows a side view of the electronic device taken along line A-A of FIG. 2B.

FIG. 3 is a flow chart of a method of using the foldable electronic device of FIGS. 2A-2C.

FIG. 4 illustrates an example of an electronic device that includes an illumination module.

FIG. 5A shows another example of a foldable electronic device in an open position.

FIG. 5B shows the foldable electronic device of FIG. 5A in a closed position.

FIG. 5C shows a side view of the electronic device taken along line A-A of FIG. 5B.

### DETAILED DESCRIPTION

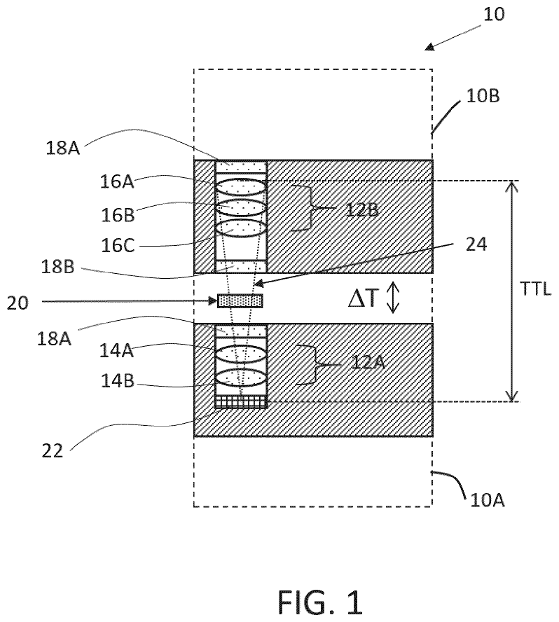

As shown in FIG. 1, an electronic device 10 includes a first part TOA and a second part 10B in an overlapping position. Each part 10A, 10B includes a respective lens unit that, together with an image sensor, form a camera unit. In particular, the first part TOA includes a first lens unit 12A, and the second part 10B includes a second lens unit 12B. The first part 12A also includes an image sensor 22 (e.g., a CMOS image sensor or an array of light sensitive pixels) or other light detector that is aligned optically with the first lens unit. The two parts 10A, 10B may be coupled together, but are separated somewhat so that there is a small distance ΔT separating the two lens units 12A, 12B from one another.

Each of the lens units 12A, 12B includes one or more optical elements. Thus, in the illustrated example, the first lens unit 12A includes a stack of two lenses 14A, 14B, and the second lens unit 12B includes a stack of three lenses 16A, 16B, 16C. The number of lenses or other optical elements in each of the lens units 12A, 12B may differ from the foregoing example in some implementations.

The stack of lenses 16A, 16B, 16C in the second lens unit 12B can be disposed, for example, between a first coverglass 18A and a second coverglass 18B. The second lens unit 12B can be configured to have a telecentric image plane such that light rays passing through the second lens unit 12B are focused on an intermediate image plane 20 located in the space 24 between the first and second lens units 12A, 12B.

The stack of lenses 14A, 14B in the first lens unit 12A is disposed, for example, between a third coverglass 18C and the image sensor 22. The first lens unit 12A can be configured to have a telecentric object plane that is located in the space 24 between the first and second lens units 12A, 12B. That is, both the image plane for the second lens unit 12B and the object plane for the first lens unit 12A are located in the space 24. Preferably, when the two lens units 12A, 12B are optically aligned with one another, the object plane for the first lens unit 12A coincides with the image plane for the second lens unit 12B.

The image sensor 22 is operable to detect light signals (e.g., visible or infrared) impinging on its surface. The image sensor 22 can be operable, for example, as a camera to capture digital image frames comprising image data which can be used to reproduce and display digital images. The camera may be implemented, for example, as a plain digital image sensor connected to an appropriate external power supply and control unit(s) and equipped with an appropriate housing and optical system. In some implementations, the camera may include, in addition to the digital sensor element, other appropriate mechanical and optical elements, as well as control electronics.

An advantage of telecentric lenses in some implementations is that their magnification does not change significantly with small variations in depth. Thus, by configuring the second lens unit 12B to have a telecentric image plane focused in the space 24 between the two lens units 12A, 12B, and by configuring the first lens unit 12A to have a telecentric object plane focused in the space 24 between the two lens units 12A, 12B, the chief light rays remain substantially parallel to the optical axis. Thus, in some implementations, the size of an image on the image sensor 22 will not vary significantly even if the distance ΔT between the two lens units 12A, 12B varies somewhat.

The optical elements in the optical units 12A, 12B can include, for example, one or more refractive elements (e.g., refractive lenses). A series of refractive lenses with relatively large diameters may be used in some instances to configure the lens units 12A, 12B. Such an arrangement, however, may result in a relatively large total track length (TTL), as well as a relatively large footprint for the device 10. On the other hand, meta optical elements, either alone or in combination with other refractive lenses, can be particularly suited to generating telecentricity. Thus, in some implementations, one or both of the optical units 12A, 12B can include at least one meta optical element (e.g., metalens) that has a metasurface (i.e., a surface with distributed small structures (e.g., meta-atoms) arranged to interact with light in a particular manner). For example, a metasurface can be a surface with a distributed array of nanostructures. The nanostructures may, individually or collectively, interact with light waves. For example, the nanostructures or other meta-atoms can be arranged to change a local amplitude, a local phase, or both, of an incoming light wave.

Although the device 10 of FIG. 1 includes a lens unit that has a telecentric image plane as well as a lens unit that has a telecentric object plane, in some implementations, the device may include only one telecentric lens unit.

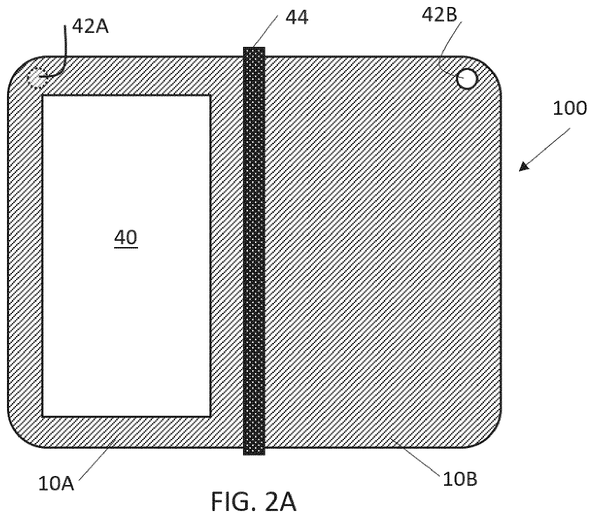

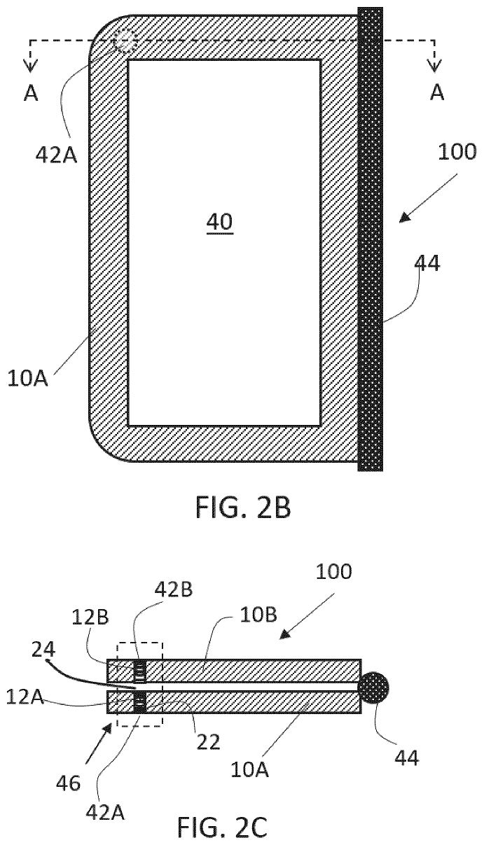

FIGS. 2A, 2B and 2C illustrate further details of an example of an electronic device 100 into which a camera unit 46 (including lens units 12A, 12B and an image sensor 22) can be integrated. The electronic device 100 can be, for example, a foldable smart phone that includes at least one touchscreen or other display screen 40 with which a user can interact. In some instances, a screen on the device's outer cover allows the user to interact with the device without opening it. The foldable smartphone can have a folding form factor and, in some implementations, may fold out on a vertical axis into a wider, tablet-like form, while still usable in a smaller, folded state. In some instances, the display screen may wrap around to the back of the device when folded or use a booklet-like design where a larger, folded screen is located on the interior side of the device. In some cases, the device 100 is horizontally-folding using, for example, a clamshell form factor.

FIG. 2A shows the electronic device 100 in an open position, whereas FIG. 2B shows the electronic device 100 in a closed position. FIG. 2C shows a side view of the electronic device 100 in the closed position taken along line A-A of FIG. 2B. The camera unit 46 (see FIG. 2C) has a total track length (TTL) that extends into both sides of the folded electronic device. In the closed position (FIGS. 2B and 2C), the lens units 12A, 12B overlap and are optically aligned with one another to allow the image sensor 22 to acquire images of objects external to the electronic device 100.

In the illustrated example, the two parts 10A, 10B of the electronic device 100 are coupled together by a hinge 44, which allows the two parts 10A, 10B to be rotated toward each other or away from each other about the common hinge. In other implementations, the device 100 has a flexible display that can be folded to allow the two parts 10A, 10B to be placed in an overlapping state such that the first and second lens units 12A, 12B of the camera unit 46 are aligned with one another.

In FIGS. 2A and 2B, reference numeral 42A indicates the location of the first lens unit 12A, and reference numeral 42B indicates the location of the second lens unit 12B. When the device 100 is in the closed arrangement (see FIGS. 2B and 2C), the positions 42A and 42B are aligned such that the first and second lens units 12A, 12B overlap. An image can be acquired by the image sensor 22, which may be disposed, for example, on the external screen-side of the smartphone (i.e., within the first part 10A). In other implementations, the image sensor 22 may be disposed on the opposite side (i.e., within the second part 10B).

In the example of FIGS. 2A through 2C, the camera unit 46 is depicted relatively close to the outer periphery of the smartphone 100. However, in some instances it may be advantageous to locate the camera unit 46 toward the interior of the smartphone (e.g., to minimize stray light when the smartphone is closed and collecting images). In some instances, a filter or physical barrier (e.g., a non-transmissive ring or gasket) can be provided around the inner aperture of one or both of the lens units 12A, 12B to help block or attenuate undesired light.

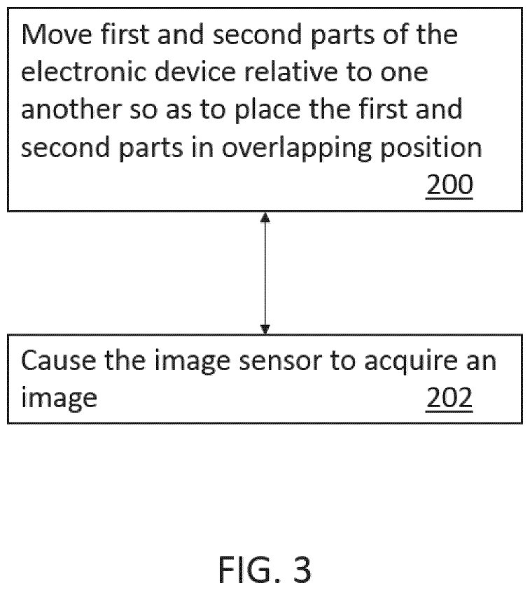

In operation, as indicated by FIG. 3, a user can move the first and second parts 10A, 10B of the electronic device 100 relative to one another (e.g., by rotating one or both of them about a hinge) so as to place the first and second parts in an overlapping position (block 200). In the overlapping position, the first and second lens units 12A, 12B are optically aligned with one another, the first and second parts 10A, 10B are separated from one another by the space 24, the second lens unit 12B has a telecentric image plane such that light rays passing through the second lens unit are focused on an intermediate image plane located in the space 24, and the first lens unit 12A has a telecentric object plane that is located in the space 24. In this state (i.e., while the first and second parts 10A, 10B are in the overlapping position), the user can cause the image sensor 22 to acquire an image based on light signals passing through the first and second lens units 12A, 12B (block 202). For example, the user can press a button on the display screen 40 to activate the camera unit 46 and capture an image.

In some implementations, the electronic device 100 is operable in two different modes. In a first mode (e.g., when the device is in an open or unfolded state), the first lens unit 12A operates alone, whereas in a second mode (e.g., when the device is in a closed or folded state), the first and second lens units 12A, 12B operate together. For example, a light sensitive active optoelectronic component such as an array of light sensitive pixels (e.g., time-of-flight (TOF) pixels) may be configured to bin pixels together in one mode and operate normally (un-binned) in another mode. A change in the mode of operation can be triggered, for example, when a user changes the device 100 from the closed (e.g., folded) position to the open (e.g., unfolded) position, or vice-versa.

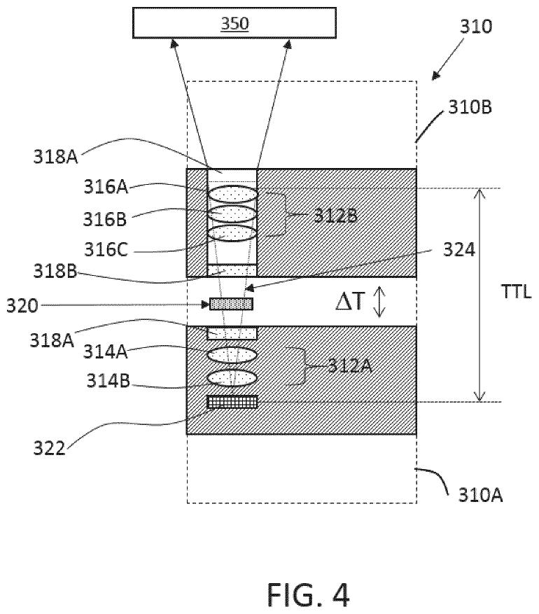

Although the foregoing description describes devices that include one or more telecentric lens units in a camera assembly, in some implementations, an electronic device can include one or more telecentric lens units in a light illumination (e.g., light projector) assembly. As shown, for example, in FIG. 4, an electronic device 310 includes a first part 310A and a second part 310B in an overlapping position. Each part 310A, 310B includes a respective lens unit that, together with a light emitter, form a light projector assembly. In particular, the first part 310A includes a first lens unit 312A, and the second part 310B includes a second lens unit 312B. The first part 312A also includes a light emitter 322 (e.g., an addressable VCSEL array) that is aligned optically with the first lens unit. The two parts 310A, 310B may be coupled together, but are separated somewhat so that there is a small distance ΔT separating the two lens units 312A, 312B from one another.

Each of the lens units 312A, 312B includes one or more optical elements. Thus, in the illustrated example, the first lens unit 312A includes a stack of two lenses 314A, 314B, and the second lens unit 312B includes a stack of three lenses 316A, 316B, 316C. The number of lenses or other optical elements in each of the lens units 312A, 312B may differ from the foregoing example in some implementations.

The stack of lenses 316A, 316B, 316C in the second lens unit 312B can be disposed, for example, between a first coverglass 318A and a second coverglass 318B.

The stack of lenses 314A, 314B in the first lens unit 312A can be disposed, for example, between a third coverglass 318C and the light emitter 322.

The first lens unit 312A can be configured to have a telecentric image plane that is located in the space 324 between the first and second lens units 312A, 312B such that light rays from the light emitter 322 passing through the first lens unit 312A are focused on an intermediate image plane 320 located in the space 324 between the first and second lens units 312A, 312B. The second lens unit 312B can be configured to have a telecentric object plane located in the space 324 as well. That is, both the image plane for the first lens unit 312A and the object plane for the second lens unit 312B are located in the space 324. Preferably, when the two lens units 312A, 312B are optically aligned with one another, the image plane for the first lens unit 312A coincides with the object plane for the second lens unit 312B.

The light emitter 322 is operable to emit light signals (e.g., visible or infrared). In some instances, the light emitter includes multiple addressable VCSELs, which can be controlled to be turned on (or off) individually or in groups, for example, to illuminate one or more objects in a scene 350 or to project a structured or other light pattern onto the object(s) in the scene. In some implementations, the light emitter may include, in addition to the light emitting elements (e.g., VCSELs), other appropriate mechanical and optical elements, as well as control electronics.

The optical elements in the optical units 312A, 312B can include, for example, one or more refractive elements (e.g., refractive lenses). A series of refractive lenses with relatively large diameters may be used in some instances to configure the lens units 312A, 312B. Such an arrangement, however, may result in a relatively large total track length (TTL), as well as a relatively large footprint for the device 310. On the other hand, meta optical elements, either alone or in combination with other refractive lenses, can be particularly suited to generating telecentricity. Thus, in some implementations, one or both of the optical units 312A, 312B can include at least one meta optical element (e.g., metalens) that has a metasurface (i.e., a surface with distributed small structures (e.g., meta-atoms) arranged to interact with light in a particular manner). For example, a metasurface can be a surface with a distributed array of nanostructures. The nanostructures may, individually or collectively, interact with light waves. For example, the nanostructures or other meta-atoms can be arranged to change a local amplitude, a local phase, or both, of an outgoing light wave.

Although the device 310 of FIG. 4 includes a lens unit that has a telecentric image plane as well as a lens unit that has a telecentric object plane, in some implementations, the device may include only one telecentric lens unit.

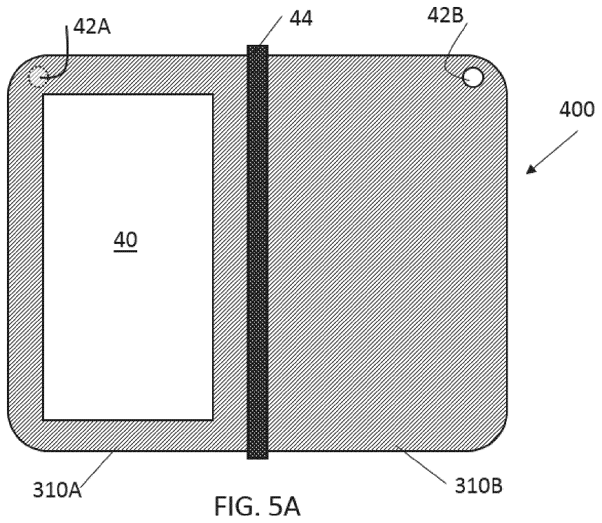

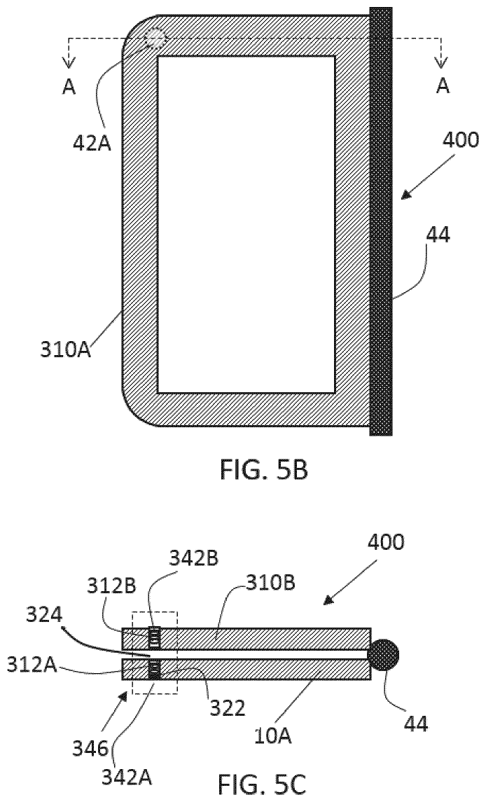

FIGS. 5A, 5B and 5C illustrate further details of an example of an electronic device 400 into which a light projector or other light illuminator unit 346 (including lens units 312A, 312B and a light emitter 322) can be integrated. The electronic device 400 can be, for example, a foldable smart phone that includes at least one touchscreen or other display screen 40 with which a user can interact. In some instances, a screen on the device's outer cover allows the user to interact with the device without opening it. The foldable smartphone can have a folding form factor and, in some implementations, may fold out on a vertical axis into a wider, tablet-like form, while still usable in a smaller, folded state. In some instances, the display screen may wrap around to the back of the device when folded or use a booklet-like design where a larger, folded screen is located on the interior side of the device. In some cases, the device 400 is horizontally-folding using, for example, a clamshell form factor.

FIG. 5A shows the electronic device 400 in an open position, whereas FIG. 5B shows the electronic device 400 in a closed position. FIG. 5C shows a side view of the electronic device 400 in the closed position taken along line A-A of FIG. 5B. The light projector 346 (see FIG. 5C) has a total track length (TTL) that extends into both sides of the folded electronic device. In the closed position (FIGS. 5B and 5C), the lens units 312A, 312B overlap and are optically aligned with one another to allow the light emitter 322 to project light (e.g., a light pattern) onto one or more objects in a scene external to the electronic device 400.

In the illustrated example, the two parts 310A, 310B of the electronic device 400 are coupled together by a hinge 44, which allows the two parts 310A, 310B to be rotated toward each other or away from each other about the common hinge. In other implementations, the device 400 has a flexible display that can be folded to allow the two parts 310A, 310B to be placed in an overlapping state such that the first and second lens units 312A, 312B of the projector 346 are aligned with one another.

In FIGS. 5A and 5B, reference numeral 342A indicates the location of the first lens unit 312A, and reference numeral 342B indicates the location of the second lens unit 312B. When the device 400 is in the closed arrangement (see FIGS. 5B and 5C), the positions 342A and 342B are aligned such that the first and second lens units 312A, 312B overlap.

In some implementations, the electronic device 400 is operable in two different modes. In a first mode (e.g., when the device is in an open or unfolded state), the first lens unit 312A operates alone, whereas in a second mode (e.g., when the device is in a closed or folded state), the first and second lens units 312A, 312B operate together.

As an example, in some implementations, in the first mode, all VCSELs in an addressable VCSEL array of the light emitter 322 generate light. In this example, the first lens unit 312A generates a flood illumination (e.g., projected dots of light are configured to blend together). In a second mode, a signal can be sent such that only some of the VCSELs in the addressable VCSEL array generate light. In that mode, the first and second lens units 312A, 312B work in concert to generate a dot or structured-light illumination, which in some instances may be over a wider field of illumination than the flood illumination in the first mode. A change in the mode of operation can be triggered, for example, when a changes the device 400 from the closed (e.g., folded) position to the open (e.g., unfolded) position, or vice-versa

In general, the two modes can be configured for two different applications. For example, the first mode may be configured for face identification, whereas the second mode may be configured for three-dimensional (3D) mapping of a relatively large space.

In some implementations, additional optical functionality (e.g., a shutter or partial mask could be actuated mechanically) may be enabled for the active optoelectronic component (e.g., the image sensor or the light emitter).

Depending on the implementation, any of the electronic devices described above can be a smartphone or other type of mobile device such as a tablet, a laptop computer, a game controller, or other type of handheld computing device.

Various modifications may be made to the foregoing examples. Accordingly, other implementations also are within the scope of the claims.

1. An apparatus comprising:
a first lens unit;
a second lens unit operable to be placed into optical alignment with the first lens unit; and
an image sensor operable to acquire an image based on light signals passing through the first and second lens units when the first and second lens units are optically aligned with one another,
wherein at least one of the first or second lens units has a telecentric image plane or a telecentric object plane.

2. The apparatus of claim 1 including an electronic device having first and second parts that are coupled together, wherein the first and second parts are separated from one another by a space when the first and second lens units are optically aligned with one another,
wherein the first lens unit and the image sensor are disposed within the first part, and the second lens unit is disposed within the second part,
wherein, when the first and second lens units are optically aligned with one another:
the second lens unit has a telecentric image plane such that light rays passing through the second lens unit are focused on an intermediate image plane located in the space, and
the first lens unit has a telecentric object plane that coincides with the intermediate image plane.

3. The apparatus of claim 1, wherein at least one of the first or second lens units includes a stack of lenses.

4. The apparatus of claim 1, wherein at least one of the first or second lens units includes a refractive lens.

5. The apparatus of claim 1, wherein at least one of the first or second lens units includes a metalens.

6. The apparatus of claim 1, wherein each of the first and second lens units includes a respective stack of lenses, and wherein at least one of the first or second lens units includes a metalens.

7. The apparatus of claim 2 wherein the first and second parts are operable to be moved relative to one another and to be placed in an overlapping position such that the first and second lens units are optically aligned with one another.

8. The apparatus of claim 7 wherein the first and second parts are coupled to one another by a hinge about which at least one of the first or second parts can rotate.

9. The apparatus of claim 2 wherein the second lens unit is disposed between first and second coverglasses, and wherein the first lens unit is disposed between a third coverglass and the image sensor.

10. An electronic device comprising:
first and second parts that are coupled together, the first part housing a first lens unit and an image sensor, and the second part housing a second lens unit, wherein the first and second parts are operable to be moved relative to one another and to be placed in an overlapping position such that the first and second lens units are optically aligned with one another, wherein, when the first and second lens units are optically aligned with one another:
the first and second parts are separated from one another by a space,
the second lens unit has a telecentric image plane such that light rays passing through the second lens unit are focused on an intermediate image plane located in the space, and
the first lens unit has a telecentric object plane that coincides with the intermediate image plane;
the image sensor being operable to acquire an image based on light signals passing through the first and second lens units when the first and second lens units are optically aligned with one another.

11. The electronic device of claim 10 further comprising an interactive display screen on at least one of the first or second parts.

12. The electronic device of claim 10, wherein the electronic device is a smartphone.

13. The electronic device of claim 12 wherein the first and second parts are coupled to one another by a hinge about which at least one of the first or second parts can rotate.

14. The electronic device of claim 10, wherein at least one of the first or second lens units includes a stack of lenses.

15. The electronic device of claim 14 wherein at least one of the first or second lens units includes a refractive lens.

16. The electronic device of claim 15 wherein at least one of the first or second lens units includes a metalens.

17. A method comprising:
moving first and second parts of an electronic device relative to one another, wherein the first and second parts are coupled together, the first part housing a first lens unit and an image sensor, and the second part housing a second lens unit, and wherein moving the first and second parts relative to one another includes placing the first and second parts in an overlapping position such that:
the first and second lens units are optically aligned with one another,
the first and second parts are separated from one another by a space,
the second lens unit has a telecentric image plane such that light rays passing through the second lens unit are focused on an intermediate image plane located in the space, and
the first lens unit has a telecentric object plane that coincides with the intermediate image plane;
the method further including causing the image sensor to acquire an image based on light signals passing through the first and second lens units while the first and second parts are in the overlapping position.

18. The method of claim 17 including rotating at least one of the first and second parts about a hinge that couples the first and second parts together.

19. An apparatus comprising:
a first lens unit;
a second lens unit operable to be placed into optical alignment with the first lens unit; and
a light emitter operable to produce light rays that pass through the first and second lens units when the first and second lens units are optically aligned with one another,
wherein at least one of the first or second lens units has a telecentric image plane or a telecentric object plane.

20. The apparatus of claim 19 including an electronic device having first and second parts that are coupled together, wherein the first and second parts are separated from one another by a space when the first and second lens units are optically aligned with one another,
wherein the first lens unit and the light emitter are disposed within the first part, and the second lens unit is disposed within the second part,
wherein, when the first and second lens units are optically aligned with one another:
the first lens unit has a telecentric image plane such that light rays produced by the light emitter and passing through the first lens unit are focused on an intermediate image plane located in the space, and
the second lens unit has a telecentric object plane that coincides with the intermediate image plane.

21. The apparatus of claim 19, wherein at least one of the first or second lens units includes a stack of lenses.

22. The apparatus of claim 19, wherein at least one of the first or second lens units includes a refractive lens.

23. The apparatus of claim 19, wherein at least one of the first or second lens units includes a metalens.

24. The apparatus of claim 19, wherein each of the first and second lens units includes a respective stack of lenses, and wherein at least one of the first or second lens units includes a metalens.

25. The apparatus of claim 20 wherein the first and second parts are operable to be moved relative to one another and to be placed in an overlapping position such that the first and second lens units are optically aligned with one another.

26. The apparatus of claim 19, wherein the light emitter includes addressable VCSELs.

27. An electronic device comprising:
first and second parts that are coupled together, the first part housing a first lens unit and a light emitter operable to produce light rays, and the second part housing a second lens unit, wherein the first and second parts are operable to be moved relative to one another and to be placed in an overlapping position such that the first and second lens units are optically aligned with one another, wherein, when the first and second lens units are optically aligned with one another:
the first and second parts are separated from one another by a space,
the first lens unit has a telecentric image plane such that the light rays produced by the light emitter and pass through the first lens unit are focused on an intermediate image plane located in the space, and
the second lens unit has a telecentric object plane that coincides with the intermediate image plane.

28. The electronic device of claim 27 wherein at least one of the first or second lens units includes a metalens.

29. A method comprising:
moving first and second parts of an electronic device relative to one another, wherein the first and second parts are coupled together, the first part housing a first lens unit and a light emitter, and the second part housing a second lens unit, and wherein moving the first and second parts relative to one another includes placing the first and second parts in an overlapping position such that:
the first and second lens units are optically aligned with one another,
the first and second parts are separated from one another by a space,
the first lens unit has a telecentric image plane such that light rays produced by the light emitter and passing through the first lens unit are focused on an intermediate image plane located in the space, and
the second lens unit has a telecentric object plane that coincides with the intermediate image plane;
the method further including causing the light emitter to produce light rays while the first and second lens units are optically aligned with one another.

30. The method of claim 29 including rotating at least one of the first and second parts about a hinge that couples the first and second parts together.

31. The method of claim 29, wherein the light rays pass through the first and second lens units and form a pattern on one or more objects.
